(19) United States
(12) Patent Application Publication
(10) Pub. No.: US 2008/0078469 A1
(43) Pub. Date: Apr. 3, 2008

(54) Bamboo composition slat system, covering and method

(76) Inventor: Han-Sen Lee, Fu-Hsing Hsiang (TW)

Correspondence Address: Harrington & Harrington;Curtis L. Harrington, Suite 250, 6300 State University Drive, Long Beach, CA, 90815, US

(21) Appl. No.: 11/529,971

(22) Filed: Sep. 29, 2006

(51) Int. Cl. B27M 1/00; B27M 3/00; B27J 7/00

(52) U.S. Cl. 144/329; 144/333

(57) ABSTRACT

A structures and process incorporates the efficient use of the annularly shaped bamboo plant to make planar shaped slats or louvers. Structures include a double rank of bamboo strips, an offset series of bamboo strips, an optional interstitial support, a single rank of bamboo strips attached to a thin wood expanse, a double thin wood expanse sandwiching a single rank of bamboo strips and a double rank of trapezoidal shaped series of bamboo strips. Steps for production include cutting a bamboo culm into strips, introduction to water for relaxing, pressing, drying, shaping, and attaching the strips adjacent each other to create a formed slat, and performing finishing shaping of the formed slat.

### FIELD OF THE INVENTION

The present invention relates to a method of using alternate materials to construct a slat and method which includes the ability to either partially or wholly eliminate planar cut wood, and which can be used to give a finish which may be one of bamboo, bamboo and planar cut wood, paper covered, heavy material covered, lacquered and painted; for constructing slats which is efficient, warp resistant, saving of natural resources.

### BACKGROUND OF THE INVENTION

Slats are utilized in a variety of window coverings, including venetian blinds, and vertical blinds. Slats have in the past been constructed of a wide variety of materials from thin metal curved along the path of their shorter dimension to produce a longitudinal stiffness, to wood from trees which is cut into planar sheets of varying thicknesses.

However, the economics of materials are changing as tree material which can be cut into slices of planar cut wood are becoming prohibitively un-economic. One portion of the market for planar cut wood is incorporated into high end, natural wood finish slats. However, this type of use requires a much lower percentage of usable wood as rejected materials rate is higher as the craftsman looks for non-blemished wood material. The result is that such louvers and slats are very expensive and have only a slim market, in favor of other window coverings, such as plantation shutters. As a result, the only viable market for horizontal slat window coverings is based upon obtaining a material which is economic at the non-natural finish, custom end of the market spectrum.

Further, even wood products which are being incorporated as non-natural finish products are becoming expensive and difficult to locate in high volumes. Even planar cut wood of poorer quality which may be used in glued composites is becoming expensive and scarce. The use of plastic and carbon based materials is not generally possible due to high cost and due to the general problem of producing thin materials which will not warp, especially in longer lengths. In some window covering structures, a warp free structure was possible only in shorter length and only with hollow structures which were geometrically reinforced to make a stable structure.

Given the volume of growth of organic plant materials almost as an unwanted by product in some areas, the continued use of natural organic materials, despite the problems outlined above, could provide significant economies on several levels. What is therefore needed is a material and method which will continue the use of organic material in horizontal slats and louvers. The needed materials should be incorporated in a way which will produce a product which is strong and is warp resistant.

### SUMMARY OF THE INVENTION

The structures and process for producing the structures of the invention enable extensive and efficient use of the annularly shaped bamboo plant to make planar shaped louvers. Bamboo plants have upwardly extending portions known as culm. The culm have annular internode areas interrupted by nodes from which a single offshoot extends.

The process for manufacturing the slats may begin with the process of cutting bamboo into strips. Taken from a cross sectional view, the angle subtended by the cuts can range from 180 degrees to only about five to ten degrees. The thickness of the bamboo material will depend upon the size of the bamboo raw material, as well as the amount of material taken off to make it flat, and further processing.

In some cases, small diameter bamboo, on the order of from about a half an inch to one inch, it was found that finished strips which are incorporated into a flattened louver had dimensions on the order of about two millimeters thick and about eight millimeters wide. Other widths and lengths are possible.

In terms of the process, long strips are cut from bamboo culm which will include the series of nodes occurring along the culm. The strips are typically lengths of carbon based material which are curved over the shorter dimension. A cross section taken transverse to the main length will show a raw strip as having the shape of an arc. As a result, the arc shaped strip has more external surface on one side than the other.

Next, the strips are boiled in water to cause the bamboo material in the strips to relax, so that they can be pressed flat. The amount of pressing, including the pressure can vary and will depend upon the transverse arc length and angular extent of curvature of the strips. Large bamboo, more than six inches in diameter can be used. A balance must be struck between the type of bamboo, the number and arc width of the strips and the amount of material lost in processing.

The pressing process occurs until the bamboo strips are dry and can maintain their flattened state. The strips are then finished on their longer edges so that even lateral dimension is achieved. The strips are then planed along their shortest dimension, particularly to reduce the height of the node areas. Planing of the nodes leaves a distinctive short parallel grain pattern.

Once the stable, dried are formed, they can be trimmed, shaped and then adjacently attached together in any number of combinations to form a stable slat shape. In one embodiment a first layer of strips are glued together laterally, and then onto an identical second layer of strips which are glued together laterally. The orientation of the two layers of strips may be aided by a sandwiching of paper or cloth material between them. The structure can be strengthened by having the bamboo strips placed in an alternating pattern as viewed from the end to form an offset pattern. A combination of both the offset pattern as well as the sandwiching of, or a combination of both.

An interstitial paper or cloth layer significantly strengthens the sheer strength of the formed slat, as well a provides a micro leveling structure as an variable sized absorbent of the glue. In effect, it helps give a variable sized complementary rigid structure to accommodate any structural anomalies in or gaps between the strips.

In a second embodiment, a first layer of strips are glued together laterally, and then onto a planar area of other material, such as a material of natural wood, perhaps with exposed grain pattern. The area of wood can be much thinner than the thickness of the strips. As by example, where strips having a thickness of about two millimeters, the planar sheet of wood material which is attached to and lies adjacent the area of wood may be one half millimeter thick. In further embodiments, the slat shape formed by adjacent strips of flattened and shaped bamboo may be sandwiched with another layer of a thin sheet of wood. In another variation, a thin layer of wood, preferably not having a grained finish, could form the interstitial layer between two slat shapes formed by adjacent strips of flattened and shaped bamboo, such that the thin wood inner layer performs the same function as the paper or cloth inner layer mentioned above.

In terms of outward appearance, a number of options are available. Strips of bamboo formed into a slat shape have a pleasing appearance with a small wrinkle pattern due to the (x) structure, which is left over from planing, occurring periodically along the strip. Strips can be very long, usually extending the length of the formed slat, without further interruption. In the alternative, shorter strips of flattened bamboo can be used to form a “planking” pattern along the louver where the ends of the shortened strips of bamboo can be seen to abut each other. The abutment ends should either occur randomly or in a pattern, but ideally any one abutment end should not be close to another abutment end along the length of any slat formed in this manner.

Slats formed with bamboo strips on both sides have a pleasing appearance both due to the regularized widths of the strips and periodic occurrence of the joint pattern. The slats formed with bamboo strips on both sides can be thinly lacquered to preserve a groove between the strips, or the slat can be lacquered to a smooth continuous surface. The lacquer can include either a glossy or matt finish.

The two layer construction, either bamboo/bamboo or bamboo/wood veneer is highly resistant to warping. Other constructions can be used, including the planar wood/bamboo/planar wood, especially where it is sought to give a wood grain appearance on both sides of the slat. Other possibilities include painting or a wrapped paper cover as was outlined in U.S. Pat. No. 6,763,873 which is incorporated by reference herein.

### BRIEF DESCRIPTION OF THE DRAWINGS

The invention, its configuration, construction, and operation will be best further described in the following detailed description, taken in conjunction with the accompanying drawings in which:

FIG. 1 illustrates a perspective view of a short length of bamboo to illustrate the manner in which strips are cut;

FIG. 2 illustrates an end view of a boiled, wet plant strip shown with respect to a press, and about to undergo pressing;

FIG. 3 illustrates an end view as seen in FIG. 2 but under compression by the press;

FIG. 4 illustrates further processing of the pressed strip of bamboo, after drying, where the trapezoidal end view shows that the bamboo strip may be further processed to a consistent shape;

FIG. 5 illustrates one configuration in which bamboo strips which have been formed and planed are combined to form a slat, along with an interstitial support material and in which the end edges have been planed even and smooth and having a generalized non-offset orientation;

FIG. 6 illustrates one configuration in which bamboo strips which have been formed and planed are combined to form a slat, along with an interstitial support material and in which the end edges have been planed even and smooth and having a generalized offset orientation causing strips near the edge to be significantly reduced in size;

FIG. 7 illustrates an embodiment where a row of bamboo strips are glued together and onto a thin planar layer of wood material;

FIG. 8 illustrates an embodiment where a row of bamboo strips are glued together and sandwiched between a pair of planar layer of wood material;

FIG. 9 illustrates an embodiment where the bamboo strips are left in a trapezoidal cross sectional shape and formed into a slat with the angled major sides complementary to each other; and

FIG. 10 is a top view of the slat seen in FIG. 5 and also illustrates the general view looking onto a bamboo finished surface similar to that which would be seen in FIGS. 6, 7, & 9 and indicates the prominent location of node areas which are characteristic of the bamboo wood grain.

### DETAILED DESCRIPTION OF THE PREFERRED EMBODIMENT

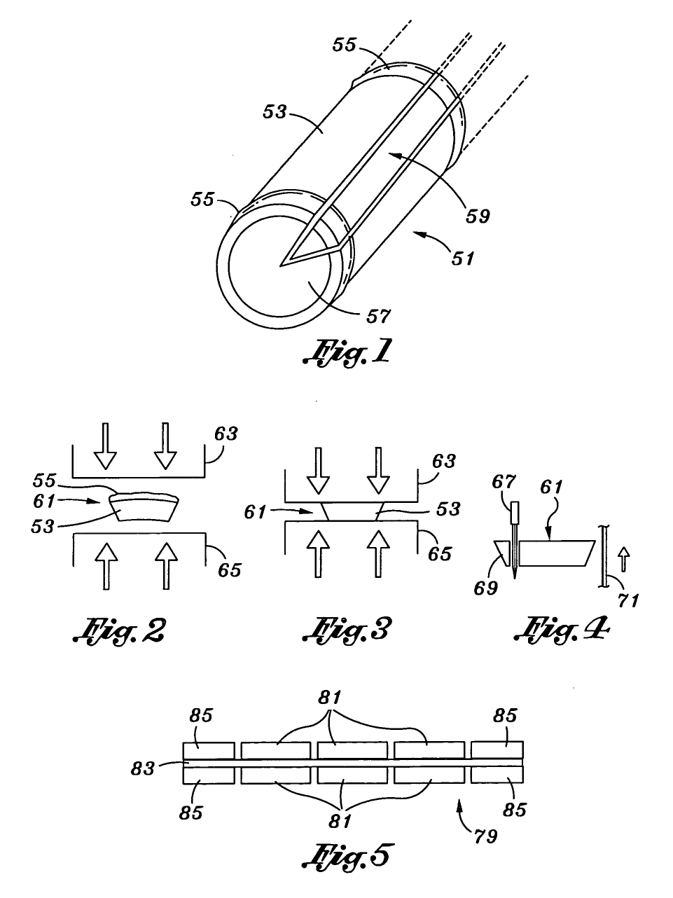

The description and operation of the shutter system of the invention will begun to be best described with reference to FIG. 1 which illustrates a perspective view of a short length of pole shaped bamboo, known as culm 51. Culm 51 includes internodes portions 53 between spaced apart nodes 55. At each node 55, an internal portion 57 of the node 55 acts to isolate each internode portion from the inside of each internode portion 53.

As is shown a section 59 of bamboo material is cut from the culm 51 and will be formed into a strip of bamboo. The section 59 is shown as a wedge shaped section with respect to the internal portion 57, but the cut need not necessarily result in a wedge shape. The geometry of the culm 51 dictates that the most efficient cut would be transverse where the culm 51 material is to be flattened. A chord cut may result in a less efficient use of material as will be shown.

It should be remembered that the diameter of the culm 51 can vary widely both in terms of its diameter and thickness. Larger diameter culm 51 will be able to produce widths or strips which have a lesser curvature. For the culm 51 shown, the angle of cut is about thirty degrees. For large diameter culm 51, the angle of choice may be up to about ninety degrees. Smaller sized culm 51 may also have a greater angle of cut, but this may result in greater stress, as will be shown.

Once the section 59 is removed from the main extent of the culm 51, the internal portion 57 of the node 55 is removed to form a longitudinal bamboo strip. The strips can then be boiled in the presence of water and perhaps some surfactant material to facilitate water entering the bamboo. Depending upon the type of bamboo plant, there may be sufficient water or reaction to heat to enable the material to become pliable by raising the temperature. The internal portion 57 of the node 55 may be removed before or after the step of introduction to water which may be by boiling to speed the introduction of water into the bamboo, in order to facilitate removal. Much of the removal may be automatic and had by feeding the sections 59 through a machine which cuts or shears off the internal portion 57.

Referring to FIG. 2, an end view of a bamboo strip 61 which is made up predominantly of internodal material 53 and a portion of node material 55. The bamboo strip 61 is preferably hot and wet just prior to the time that it will be compressed in a press having a first press member 63 and a second press member 65. The press members 63 and 65 can be heated to enhance pressing and to help dry the bamboo strips 61 once they are pressed.

The internode material 53 is seen as having a curved trapezoidal shape having a shorter more sharply curved side opposite a longer more gently curved side. A pair of angled sides are seen which correspond to the angular cut seen in FIG. 1. A small amount not node material 55 may be seen. Now in some cases, the presence of the node material 55 may inhibit pressing. This may depend upon the type of bamboo plant, the level of the node material 55, as well as the node material 55 susceptibility to moisture and heat.

As a result, and depending upon the machinery available and the best results to be achieved, the steps of removing the internal portion 57 of the node 55, and the step of either cutting or grinding the uppermost part of the node 55 may be accomplished in any order. Further, the introduction to the presence of water or the boiling step may in some cases be accomplished on the whole culm 51.

For example, depending upon the type of bamboo and machinery, the culm 51 may or may not be introduced to water or boiled and then and then pressed through a series of cutting blades passing through a restrictive die which simultaneously forms all of the bamboo strips 61 for a single length of culm 51. The machinery may also then include a pulling device which grabs each of the bamboo strips 61 and puts them through a restrictive die portion which may remove the sections of the internal portions 57 of the nodes 55 automatically. Pulling the bamboo strips 61 through a restrictive die (not shown) could be used to make a gross approximating cut for both the internal portions 57 of the nodes 55 and the outside of the nodes 55 automatically. Given that further processing is almost certainly necessary after the bamboo strips 61 have been pressed and dried, it is not expected that other than gross processing will be had.

If the above steps are done while the bamboo is wet and hot, other accommodation will be had to facilitate grasping and handling during processing. It should be remembered that any surface alteration can occur during processing and that any digs or impressions from grasping or pulling will be lessened for non water containing and cold bamboo. In the alternative, where manual handling is had, the culm 51 can be cut into halves, quarters and eighths (if necessary) by simply running each fraction (whole culm 51, then halves and then quarters, etc.) through a loose die in a stepwise manufacturing setup. It is important that some mechanical solution prevent any spiraling of the section 59, in order to minimize problems during manufacture.

By another example, the cutting, removal of the internal portion 57 of the node 55 and partial removal of the outside of node 55 can be had sequentially. In any event, the first press member 63 can be flat metal or it can be a softer material where the outside of the node 55 is to be removed later. In other words, the first press member 63 contact of the highest portion of the node 55 should not leave any internode portion of the bamboo strip 61 unflattened.

Conversely, the ability to use a flat metal first press member 63 may depend upon how hot and moisture laden the bamboo strip 61 is at the time of pressing. Where the node 55 can be compressed and somewhat keep its somewhat more flattened shape, the gross finishing step for removal of all of the node 55 down to the level of the internode portion 53 can be accomplished more efficiently and with a higher quality and higher strength product.

Referring to FIG. 3, a view of the bamboo strip 61 in the press in which the first press member 63 and second press member 65 are brought together under high pressure is seen. The amount of pressure will be dependent upon the number of bamboo strips 61 present, the type and size of the culm 51 and the moisture content.

The node 55 is not shown, for convenience, in FIG. 3. As before, it could be present but reduced in size, it could have been removed before processing, or it could be accommodated by a first press member 63 (selected because the first press member 63 is facing the node 55) having a deformable surface material.

FIG. 3 illustrates that regardless of the initial treatment of the node 55, the overall resulting shape of the internode material 55, taken from an axial view, is that of a trapezoidal shape. The internal and external curved shapes have been made linear or flat, and the prior arc faces have become somewhat trapezoidally shaped. It is understood that to absolutely save material, the trapezoidal surfaces in this end view could be only slightly sanded and the strips of bamboo placed alternately together.

Referring to FIG. 4, a case where each of the bamboo strips 61 are further processed to remove the trapezoidal shapes is illustrated. A knife 67 is seen as cutting a triangular cross section trapezoidal portion 69. In the alternative a moving length of sanding material 71 can be used to take off an equivalent amount of material to the triangular cross section trapezoidal portion 69. It can be seen that a rectangular cross section is being achieved. As before, for a known type of bamboo with a known diameter, the angles of the resulting trapezoidal shapes should be fairly uniform and amenable to slight further processing, typically limited to sanding or smoothing at an angle, to achieve a complementary enough relationship to the other bamboo strips 61 to form a stable slat. It should be noted that any trapezoidal angle will produce an enhanced adjacent surface area which will provide for greater strength.

By virtue of the geometry and cut of the a bamboo strip 61, the surface at the wider side of the trapezoidal shape seen in FIGS. 2,3 & 4 will have a smooth or waxy appearance, while the surface at the narrower side of the trapezoidal shape seen in FIGS. 2,3 & 4 will have a rougher internal appearance. It is expected, depending upon the type of bamboo that these two surfaces, previously the inside and outside surfaces, will be sanded smooth so as to assume a fairly even, similar appearance. On either side of the bamboo strip 61, the node area 55 will appear like a string of short lines and the bamboo node pattern will persist regardless of which side of the bamboo strip 61 is exposed. Given the amount of processing necessary to achieve a flattened surface, the bamboo strip 61 exterior shiny, glossy or waxy surface will likely not be able to survive the processing, and the processing will conclude with lengths of bamboo having sides which are not different from each other.

Referring to FIG. 5, an end view of a formed slat 79 is shown. Slat 79 includes a plurality of individual finished bamboo strips 81. Bamboo strips 81 are preferably uniformly finished so that each will have a common shape and a consistent fit with each other. FIG. 5 illustrates finished bamboo strips 81 having a rectangular cross sectional area, but this need not be the case.

In one embodiment, it has been found that a series of five individual finished bamboo strips 81 having dimensions of about two millimeters thick and a width of about seven to eight millimeters wide can form an overall slat having a width of about thirty five millimeters. A double rank of individual finished bamboo strips 81 will cause the slat 79 to have an overall thickness of between four and five millimeters. Any spacing seen between the individual finished bamboo strips 81 is for illustration only, with the final assembled slat 79 to be glued and pressed together with minimal spacing between the individual finished bamboo strips 81.

A layer of planar interstitial material 83 is shown as lying beneath the upper rank of individual finished bamboo strips 81 and above the upper rank of individual finished bamboo strips 81. One of the major surfaces of each of the individual finished bamboo strips 81 contacts and is glued to fit with respect to the layer of planar interstitial material 83 to result in both superior strength and stability. As seen in FIG. 5, each of the individual finished bamboo strips 81 has a major surface (facing the layer of planar interstitial material 83) and two side surfaces (except for end strips 81) available for gluing.

The layer of planar interstitial material 83 can be formed from any variety of materials, with the only preference that it be bondable to another material such as glue or the like, and have a significant shear stress. Where the layer of planar interstitial material 83 is porus, it should have the ability to absorb bonding material and add to the rigidity and shear strength. The layer of planar interstitial material 83 may be a non woven fabric, a woven fabric, an elastic, a gauze material, jute, or a deformable material. The glue can be cyanoacrylate, wood glue, epoxy, or any other material which can penetrate and bond bamboo. Further, to enhance bonding, grooves, or other features may be formed into the individual finished bamboo strips 81 on any side to form a better fit. Other methods of joining might include ultrasonic welding with glues or other flowing agents, as well as heat, radio or microwaves, any of which may be delivered under conditions of significant to extreme pressure.

The slat 79 from above resembles plank flooring. Depending upon the micro-machining capability, other features may be formed on the individual finished bamboo strips 81 forming the slats 79. Examples include the same type of features used in flooring, such as tongue and groove, dove tail, simple grooves and other features.

Also seen in FIG. 5 is the possibility that certain ones of the individual finished bamboo strips 81 located to the outside may be slightly narrower than the individual finished bamboo strips 81 located to the inside. These are outside individual finished bamboo strips 85 and the possibility is contemplated that an overall exterior finishing step for the slat 79 may result in the removal of outside material. An overall finishing step which sands to an even outside edge surface of slat 79 will probably be planned for in a way that removed material on the outside resulting in smaller width outside individual finished bamboo strips 85. During the reduction step, the layer of planar interstitial material 83 will be removed simultaneous with the removal of the layer of planar interstitial material 83. Since all of the individual finished bamboo strips 81 will be harder than the layer of planar interstitial material 83, no other accommodation need be made in overall outside finishing. Outside finishing of the slat occurs as if it is a single expanse of thin planar wood. Sanding and other leveling finishing steps can occur on the main upper and lower areas of the slat 79.

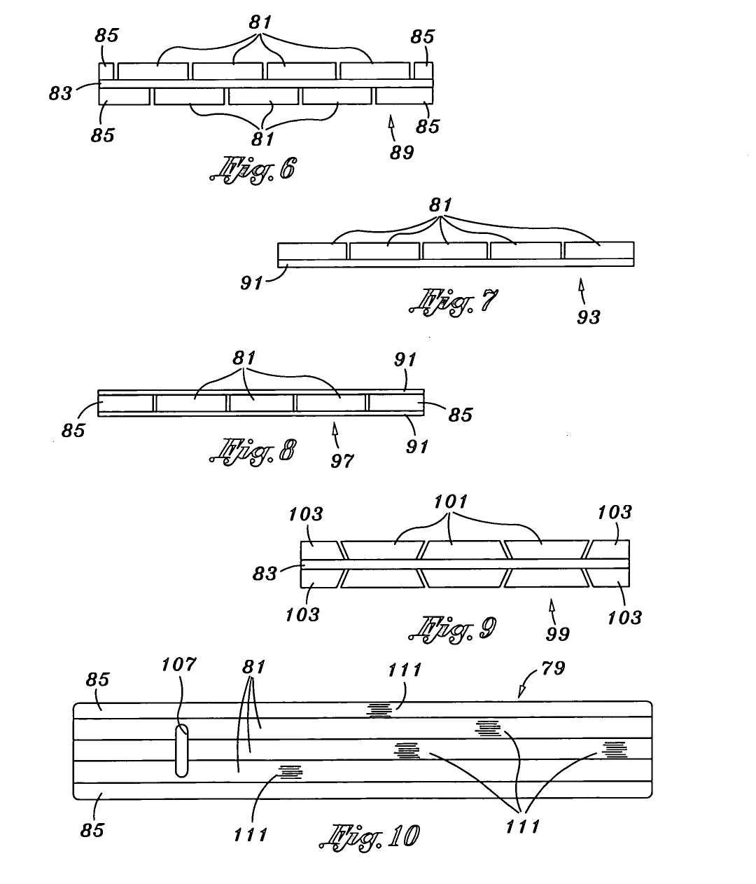

Referring to FIG. 6, one configuration in which the plurality of individual finished bamboo strips 81 have been formed and planed are combined to form a slat 89, but where the bamboo strips 81 in the top rank are offset with respect to the bamboo strips 81 of the bottom rank. This offset arrangement may result in additional waste where uniform individual finished bamboo strips 81 are used, as for example the smaller width outside individual finished bamboo strip 85 seen in the upper left rank would have had significant material removed to reduce it to the size seen. The alternative would be to use a width of smaller width of outside individual finished bamboo strip 85 which was narrow enough to avoid waste, but wide enough to insure than an even finish could be had with respect to the uniform individual finished bamboo strips 81 below, so that both could become outside individual finished bamboo strips 85.

The arrangement in FIG. 6 might also suggest the ability in some circumstances to eliminate or minimize the thickness of the planar interstitial material 83. The planar interstitial material 83 should not be eliminated unless the structural integrity of the resulting slat 79, or slat 89 could be assured. However it may also be that the planar interstitial material 83 might be made to completely re-form during bonding of the plurality of individual finished bamboo strips 81.

Referring to FIG. 7, a further configuration in which the plurality of individual finished bamboo strips 81 have been formed into a single rank and attached to a (preferably but not necessarily) a single planar expanse of thin wood 91 to form a resulting slat 93, is seen. The dimensions of the resulting slat 93 is not unlike the dimensions for its components mentioned earlier. The plurality of individual finished bamboo strips 81 are about two millimeters thick and about seven to eight millimeters wide. The resulting slat 93 is about thirty five millimeters wide (but may be of any width).

The term “single planar expanse” indicates that the material generally is not made into strips, and is generally expected to cover at least half of the breadth of the slat formed using it. Of course, the manufacturing process may deliberately employ amounts of thin wood 91 which do not extend the whole length of the formed slat, or which may include a series of smaller areas of thin wood 91 for patterning purposes or simply because longer lengths of such single planar expanse of thin wood 91 are unavailable. All of these circumstances are contemplated, the idea being that a single or multiple planar expanse of thin wood 91 will provide some common support to at least one of the plurality of individual finished bamboo strips 81.”

Consequently the width of the planar expanse of thin wood 91 is about thirty five millimeters wide. However, the thickness of the planar expanse of thin wood 91 can be much thinner, on the order of one half to one third of a millimeter. The “veneer” member acts as a shear resistant surface upon which the plurality of individual finished bamboo strips 81 is fixed, and provides a low cost finished wood-grain surface. The resulting slat 93 can therefor employ a high cost and high quality expanse of thin wood 91 while at the same time providing a low cost, structurally sound window covering slat.

Further, the support had from the plurality of individual finished bamboo strips 81 enables the outwardly directed face of the high quality expanse of thin wood 91 to be processed quickly with good support and little chance of damage to the resulting slat 93. In a horizontal blind set, the high quality expanse of thin wood 91 will typically be oriented upwardly. The resulting slat 93 also provides a two sided “reversible” style which shows a high quality expanse of thin wood 91 when the slats 93 are oriented horizontally or tilted toward the user, but provides a bamboo look when the slats 93 are tilted downwardly away from the user, in a typical window covering application.

Referring to FIG. 8, a series of plurality of individual finished bamboo strips 81 form a single rank and are sandwiched by two the high quality expanse of thin wood 91 to form a slat 97. Relying upon the dimensions previously stated, the resulting slat 97 would have a thickness contribution of from about one third of a millimeter for each high quality expanse of thin wood 91 combined with the two millimeter thickness of the series of plurality of individual finished bamboo strips 81 to form a rigid, non-warping slat 97 having a thickness of from two and two thirds millimeters to about three millimeters. For the same amount of wood supplied in the same thickness to form a complete one-piece slat, four of the slats 97 could be formed with the use of the plurality of individual finished bamboo strips 81 seen in the figures. The resulting slat 97 appears as a complete one-piece slat made from the same wood used for the high quality expanse of thin wood 91.

The edges of the slat 97 are so thin that the grain of the bamboo is negligible. The staining of the slat 97 would produce an effect which further enhanced the impression that the slat 97 is made from one volume of high quality wood corresponding to the high quality expanse of thin wood 91. Part of this impression is due to the thin nature of the slat 97 produced. Where applicable, the outwardly directed edges of the outside individual finished bamboo strips 85 can be painted or finished in any number of ways.

Referring to FIG. 9, a slat 99 is made from flattened internodes portions 53 as a plurality of individual finished trapezoidally cross section shaped bamboo strips 101. As before, the planar interstitial material 83 marks the middle of a classification of the trapezoidally cross section shaped bamboo strips 101 into an upper first rank and a lower second rank. Note that each adjacent one of the bamboo strips 101 is oppositely oriented to interfit closely. The use of angled interfaces between adjacent bamboo strips increases the bonding surface area.

It should be noted that if the type of bamboo being used has a different finish on one side than the other, that the slat 99 may exhibit a pattern of alternating finishes, but as stated earlier, the processing necessary to complete the plurality of individual finished bamboo strips 81 is such that the opposite main sides are expected to be indistinguishable. Further, although the just pressed bamboo strip 61 seen in FIG. 3 is shown with a trapezoidal cross section, the plurality of individual finished trapezoidally cross section shaped bamboo strips 101 are expected to have had all their surfaces processed. The continued presence of the angled side edges are not due to non-processing of those edges seen in FIG. 3, but represents side edges which have been treated by sanding. The sanding operation also insures that the same angles will be maintained for all shaped bamboo strips 101 to insure that they will be fixably joined together efficiently. The visual appearance of the slat 99 is expected to be the same as for slats 79 and 89.

Also seen are outside individual finished hemi-trapezoidal bamboo strips 103. The use of plurality of individual finished trapezoidally cross section shaped bamboo strips 101 probably eliminates any significant advantage from an offset configuration and would not be expected to produce any additional significant waste. The normal processing of the slat 99 to form the edges after formation of the overall slat 99 can proceed in the same was as was the case for slats 79, 89, 93, and 97.

Referring to FIG. 10 is a top view of the slat 79 seen in FIG. 5 and also illustrates the general view looking onto a bamboo finished surface similar to that which would be also seen in FIGS. 6, 7, & 9 with respect to slats 89,93 and 99. A lift cord opening 107 is made through the slat 79 to accommodate a lift cord and to accommodate a tilting of the slat 79 about the lift cord. Also seen are the plurality of individual finished bamboo strips 81 having a generally even width, and by comparison the outside individual finished bamboo strips 85 which are seen as somewhat narrower.

Importantly, the prominence and identifiability of the location of the node areas 111 which are characteristic of the bamboo wood grain. The node areas 111 appear as a series of short lines over defined areas of the slat 79.

While the present invention has been described in terms of a system and method for forming of various constructions of slats from strips of bamboo, one skilled in the art will realize that the structure and techniques of the present invention can be applied to many structures, including any structure or technique where joinder with enhanced contact structures for slat formation with bamboo, both for appearance and for inexpensive structural reinforcement.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A slat for a window covering comprising:
a first plurality of shaped bamboo strips having a first main surface and a second main surface, and lateral surfaces, said first plurality of shaped bamboo strips attached adjacently to each other by their respective lateral surfaces; and
a support structure having a first side and a second side said first side of said support structure attached to said second main surfaces of said first plurality of shaped bamboo strips.

2. The slat for a window covering as recited in claim 1 wherein said lateral surfaces of said first plurality of shaped bamboo strips are parallel planar.

3. The slat for a window covering as recited in claim 1 wherein said lateral surfaces of said first plurality of shaped bamboo strips are angled with respect to each other.

4. The slat for a window covering as recited in claim 1 wherein said node areas of said bamboo strips are clearly identifiable.

5. The slat for a window covering as recited in claim 1 wherein said support structure is a second plurality of shaped bamboo strips having a first main surface and a second main surface, and lateral surfaces, said second plurality of shaped bamboo strips attached adjacently to each other by their respective lateral surfaces and to said first plurality of shaped bamboo strips by said second main surfaces of said second plurality of shaped bamboo strips.

6. The slat for a window covering as recited in claim 5 wherein said second plurality of shaped bamboo strips are horizontally offset with respect to said first plurality of shaped bamboo strips.

7. The slat for a window covering as recited in claim 1 wherein said support structure is a first planar expanse of thin wood.

8. The slat for a window covering as recited in claim 7 and further comprising a second planar expanse of thin wood attached to said first main surface of said first plurality of shaped bamboo strips, said first and second planar expanses of thin wood sandwiching said first plurality of shaped bamboo strips therebetween.

9. The slat for a window covering as recited in claim 1 and further comprising a second plurality of shaped bamboo strips having a first main surface and a second main surface, and lateral surfaces, said second plurality of shaped bamboo strips attached adjacently to each other by their respective lateral surfaces and to said second side of said support structure.

10. The slat for a window covering as recited in claim 1 wherein said support structure is a planar material comprising at least one of a non woven fabric, a woven fabric, an elastic material, a gauze material, a jute material, and a deformable material.

11. The slat for a window covering as recited in claim 10 and further comprising a second plurality of shaped bamboo strips having a first main surface and a second main surface, and lateral surfaces, said second plurality of shaped bamboo strips attached adjacently to each other by their respective lateral surfaces and to said second side of said support structure.

12. A process for forming a slat for a window covering comprising the steps of:
cutting a bamboo culm into strips to form bamboo strips;
introducing the bamboo strips to water cause them to relax;
pressing said relaxed bamboo strips;
allowing said relaxed bamboo strips to dry while in a pressed state;
shaping said dried pressed bamboo strips to a generally uniform shape;
attaching said dried pressed bamboo strips adjacent each other and to a support surface to create a formed slat.

13. The process for forming a slat for a window covering as recited in claim 12 wherein said shaping step includes at least one of cutting and sanding.

14. The process for forming a slat for a window covering as recited in claim 12 wherein said shaping step is repeated with respect to said formed slat.

15. The process for forming a slat for a window covering as recited in claim 12 wherein said shaping step forms a generally uniform rectangular solid shape.

16. The process for forming a slat for a window covering as recited in claim 12 and further comprising the step of lacquering said formed slat.
